(19) United States
(12) Patent Application Publication
(10) Pub. No.: US 2012/0296555 A1
(43) Pub. Date: Nov. 22, 2012

(54) METHOD FOR OPERATING AN INTERNAL COMBUSTION ENGINE

(75) Inventors: Luca SCAVONE, Moncalieri (IT); Alberto CORSIATTO, Torino (IT)

(73) Assignee: GM GLOBAL TECHNOLOGY OPERATIONS LLC, Detroit, MI (US)

(21) Appl. No.: 13/472,693

(22) Filed: May 16, 2012

(30) Foreign Application Priority Data
May 19, 2011 (GB) 1108385.4

(51) Int. Cl. G06F 7/00

(52) U.S. Cl. 701/104

(57) ABSTRACT

A method for operating an internal combustion engine includes injecting a quantity of fuel in the engine per engine cycle. A total value of the fuel quantity is evaluated as the sum of a fuel quantity base value and a fuel quantity correction value. The fuel quantity base value is determined based on a requested value of engine torque to be generated in the engine cycle. The fuel quantity correction value is determined based on an engine torque error in a previous engine cycle, which is calculated as a difference between a value of engine torque generated in the previous engine cycle and the requested value of engine torque for the previous engine cycle.

### CROSS-REFERENCE TO RELATED APPLICATION

This application claims priority to British Patent Application No. 1108385.4, filed May 19, 2011, which is incorporated herein by reference in its entirety.

### TECHNICAL FIELD

The technical field generally relates to a method for operating an internal combustion engine, in particular an internal combustion engine of a motor vehicle, such as a diesel engine.

### BACKGROUND

As known, a conventional diesel engine comprises an engine block including a plurality of cylinders, each of which accommodates a piston and is closed by a cylinder head that cooperates with the piston to define a combustion chamber. The combustion chambers are individually equipped with a fuel injector for injecting fuel directly therein, and the pistons are coupled to a common crankshaft, so that a reciprocating movement of each piston is transformed in a rotation of the crankshaft and vice versa.

Each combustion chamber cyclically operates an engine cycle. The engine cycle generally involves two complete rotations of the crankshaft, which correspond to four strokes of the piston in the related cylinder, including an intake stroke, a compression stroke, an expansion stroke, and an exhaust stroke. The fuel is injected in the combustion chamber nearly at the end of the compression stroke, so that the power generated by the combustion of the fuel shoves the piston in the expansion stroke, thereby generating torque at the crankshaft.

The diesel engine is configured and operated so that each phase of the engine cycle, such as for example the fuel injection and combustion phase, occurs in the different combustion chambers at different times. As a result, the diesel engine globally performs engine cycles in sequence, wherein the last (or current) engine cycle of the sequence is always performed in a different combustion chamber than the previous engine cycle, and so forth.

The diesel engine is typically operated with the aid of an engine control unit (ECU), a task of which is to determine the fuel quantity to be injected during each engine cycle, and to operate the related fuel injector accordingly. The fuel quantity is traditionally determined according to a feed-forward control strategy, which provides for the ECU to determine a requested value of engine torque to be generated during the current engine cycle, usually on the basis of an accelerator pedal position, and then to use this engine torque requested value to evaluate the fuel quantity.

In order to improve the engine performance and reduce the polluting emissions, modern strategies provide for the ECU to determine the fuel quantity using also a closed control loop of the generated engine torque. As a matter of fact, the ECU evaluates the fuel quantity to be injected in the current engine cycle as a sum of a fuel quantity base value and a fuel quantity correction value.

The fuel quantity base value is determined on the basis of the requested value of engine torque, according to the conventional feed-forward strategy, while the fuel quantity correction value is determined using the above mentioned closed control loop of the engine torque, which generally provides for regulating the fuel quantity correction value on the basis of an error between the requested value of engine torque for the previous engine cycle and a measured value of the engine torque actually generated in that previous engine cycle.

Since each engine cycle is performed in a different combustion chamber than the preceding one, this closed control loop is particularly effective only if all combustion chambers of the diesel engine are equipped with a sensor capable to provide a signal directly related to the engine torque. This sensor is currently embodied as a sophisticated in-cylinder pressure sensor, which is suitable to measure the variation of the pressure within the combustion chamber during an engine cycle, thereby allowing the ECU to calculate parameters strictly related to the engine torque, such as for example the Indicated Mean Effective Pressure (IMEP).

However, in-cylinder pressure sensors of this kind are very expensive and thus increase the diesel engine cost considerably, so that it is generally advisable not to have an in-cylinder pressure sensor for each cylinder. In particular, a small sized diesel engine can generally be provided with one (or two) in-cylinder pressure sensor, which can obviously be associated to a single combustion chamber.

As a consequence, the engine torque can be measured only for the engine cycles that occur in the combustion chambers provided with the sensor, thereby causing problems on the closed control loop of the engine torque, which leads to an excessive oscillation of the torque actually generated by the diesel engine, and causing also problems in every other powertrain system that is controlled on the basis of the in-cylinder pressure, especially after an abrupt change of the engine torque requested value due to the driver acting on the accelerator pedal.

At least one object herein is therefore to improve the closed control loop of the engine torque generated by an internal combustion engine that does not have an in-cylinder pressure sensor for each cylinder.

Another object is to provide a reliable estimation of the engine torque that this internal combustion engine generates in every engine cycle (with or without in-cylinder pressure measurement available for that engine cycle).

Still another object is of attaining these goals with a simple, rational and rather inexpensive solution. In addition, other objects, desirable features and characteristics will become apparent from the subsequent summary and detailed description, and the appended claims, taken in conjunction with the accompanying drawings and this background.

### SUMMARY

In an embodiment, a method for operating an internal combustion engine includes injecting a quantity of fuel in an internal combustion engine per engine cycle. A total value of the fuel quantity injected for each engine cycle is evaluated as the sum of a fuel quantity base value and a fuel quantity correction value. The fuel quantity base value is determined on the basis of a requested value of engine torque to be generated in the engine cycle. The fuel quantity correction value is determined on the basis of an engine torque error in a previous engine cycle. The engine torque error is calculated as a difference between a value of engine torque generated in the previous engine cycle and the requested value of engine torque for the previous engine cycle.

In this regard, the value of engine torque generated in an engine cycle is estimated by:
calculating an incremental value of fuel quantity as a difference between the fuel quantity correction value determined for the engine cycle and the fuel quantity correction value determined for the previous engine cycle,
calculating an incremental value of engine torque generated in the engine cycle due to this incremental value of fuel quantity, and
estimating the value of engine torque generated in the engine cycle as the sum of the engine torque incremental value of the engine torque requested value for the engine cycle and of the engine torque error calculated for the previous engine cycle.

This strategy is based on the idea that the engine torque error, i.e. the difference between the engine torque requested value and the value of torque actually generated, can change from one engine cycle to another only for the contribute of torque provided by the closed control loop. This strategy achieves a reliable estimation of the value of engine torque generated in an engine cycle, which can be effectively used instead of the engine torque measured value for those engine cycles that are performed in combustion chambers and that are measured with the in-cylinder pressure sensor, thereby improving the whole closed loop control strategy.

The estimated value of engine torque can be used also for other applications that need a real time engine torque evaluation, such as for example hybrid applications in which the engine torque request should be split between the internal combustion engine and an electric motor.

According to another embodiment, the engine torque incremental value is calculated by:
calculating an intermediate value of the fuel quantity injected during the engine cycle as a difference between the fuel quantity total value and the fuel quantity incremental value for the engine cycle,
estimating a first value of engine torque generated in the engine cycle due to this intermediate value of the fuel quantity,
estimating a second value of engine torque generated in the engine cycle due to the total value of the fuel quantity, and
calculating the engine torque incremental value as the difference between the engine torque second value and the engine torque first value.

In particular, the estimations of the first and the second engine torque values can be performed by a conversion map receiving a fuel quantity value as input and returning an engine torque value as output. In this regard, a more reliable estimation of the engine torque incremental value is realized because the conversion maps currently available for estimating an engine torque starting from a fuel quantity are generally not very reliable for small quantities of fuel, so that it is not advisable to estimate the engine torque incremental value using directly the incremental value of the fuel quantity as input of these maps.

According to an embodiment, the requested value of engine torque to be generated in an engine cycle and the value of engine torque generated in the engine cycle are individually filtered by a filter of the same kind, for example a low-pass filter, before calculating the engine torque error for the related engine cycle. In this regard, filtering the value of engine torque actually generated in an engine cycle disregards values affected by noises. Since this engine torque value is filtered, the same low-pass filter is applied also to the requested torque value to avoid the determination of an unreliable engine torque error.

The methods contemplated herein can be carried out using a computer program comprising a program-code for carrying out all the steps of the methods described above, and in the form of a computer program product comprising the computer program.

The computer program product can be embodied as an internal combustion engine comprising an engine control unit (ECU), a memory system associated with, for example, electrically connected to, the ECU, and the computer program stored in the memory system, so that, when the ECU executes the computer program, all the steps of the method described above are carried out.

The methods can be also embodied as electromagnetic signals, the signals being modulated to carry a sequence of data bits that represent a computer program to carry out all steps of the methods.

In another embodiment, an apparatus for operating an internal combustion engine comprises an injection means for injecting fuel in the internal combustion engine, and a control means configured for:
operating the injection means to inject a quantity of fuel in the internal combustion engine per engine cycle,
evaluating a total value of the fuel quantity injected for each engine cycle as the sum of a fuel quantity base value and a fuel quantity correction value,
determining the fuel quantity base value on the basis of a requested value of engine torque to be generated in the engine cycle,
determining the fuel quantity correction value on the basis of an engine torque error in a previous engine cycle,
calculating the engine torque error in the previous engine cycle as a difference between a value of engine torque generated in the previous engine cycle and the requested value of engine torque for the previous engine cycle, and
estimating the value of engine torque generated in an engine cycle by:
   calculating an incremental value of fuel quantity as a difference between the fuel quantity correction value determined for the engine cycle and the fuel quantity correction value determined for the previous engine cycle,
   calculating an incremental value of engine torque generated in the engine cycle due to this incremental value of fuel quantity, and
   estimating the value of engine torque generated in the engine cycle as the sum of the engine torque incremental value, of the requested value of engine torque for the engine cycle, and of the engine torque error calculated for the previous engine cycle.

As described above, this apparatus allows for the estimation of a reliable value of the engine torque actually generated during every engine cycle, thereby improving the whole closed loop control strategy of the engine torque.

In a further embodiment, an automotive system includes:
an internal combustion engine (ICE) comprising an engine block defining a set of cylinders, each of which is provided with a reciprocating piston, with a cylinder head that cooperates with the pistons to define a combustion chamber, and with a fuel injector for injecting fuel into the combustion chamber; and
an electronic control unit (ECU) in communication with the fuel injectors, wherein the ECU is configured for:
   operating the fuel injectors to inject a quantity of fuel in the related combustion chamber per engine cycle,
   evaluating a total value of the fuel quantity injected for each engine cycle as the sum of a fuel quantity base value and a fuel quantity correction value,
   determining the fuel quantity base value on the basis of a requested value of engine torque to be generated in the engine cycle,
   determining the fuel quantity correction value on the basis of an engine torque error in a previous engine cycle,
   calculating the engine torque error in the previous engine cycle as a difference between a value of engine torque generated in the previous engine cycle and the requested value of engine torque for the previous engine cycle,
   estimating the value of engine torque generated in at least an engine cycle by:
      calculating an incremental value of fuel quantity as a difference between the fuel quantity correction value determined for the engine cycle and the fuel quantity correction value determined for the previous engine cycle,
      calculating an incremental value of engine torque generated in the engine cycle due to this incremental value of fuel quantity, and
   estimating the value of engine torque generated in the engine cycle as the sum of the engine torque incremental value, of the requested value of engine torque for the engine cycle, and of the engine torque error calculated for the previous engine cycle.
      This automotive system allows for the estimation of a reliable value of the engine torque actually generated during every engine cycle, thereby improving the whole closed loop control strategy of the engine torque.

### BRIEF DESCRIPTION OF THE DRAWINGS

The various embodiments will hereinafter be described in conjunction with the following drawing figures, wherein like numerals denote like elements, and wherein:

FIG. 1 is a schematic illustration of an automotive system of a motor vehicle in accordance with an exemplary embodiment;

FIG. 2 is a cross-sectional view of an internal combustion engine of the automotive system of FIG. 1 taken along the line II-II;

FIG. 3 is flowchart illustrating an injection control strategy according to an embodiment; and

FIG. 4 is a flowchart illustrating a method involved in the control strategy of FIG. 3, for estimating the engine torque generated by the internal combustion engine, according to an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

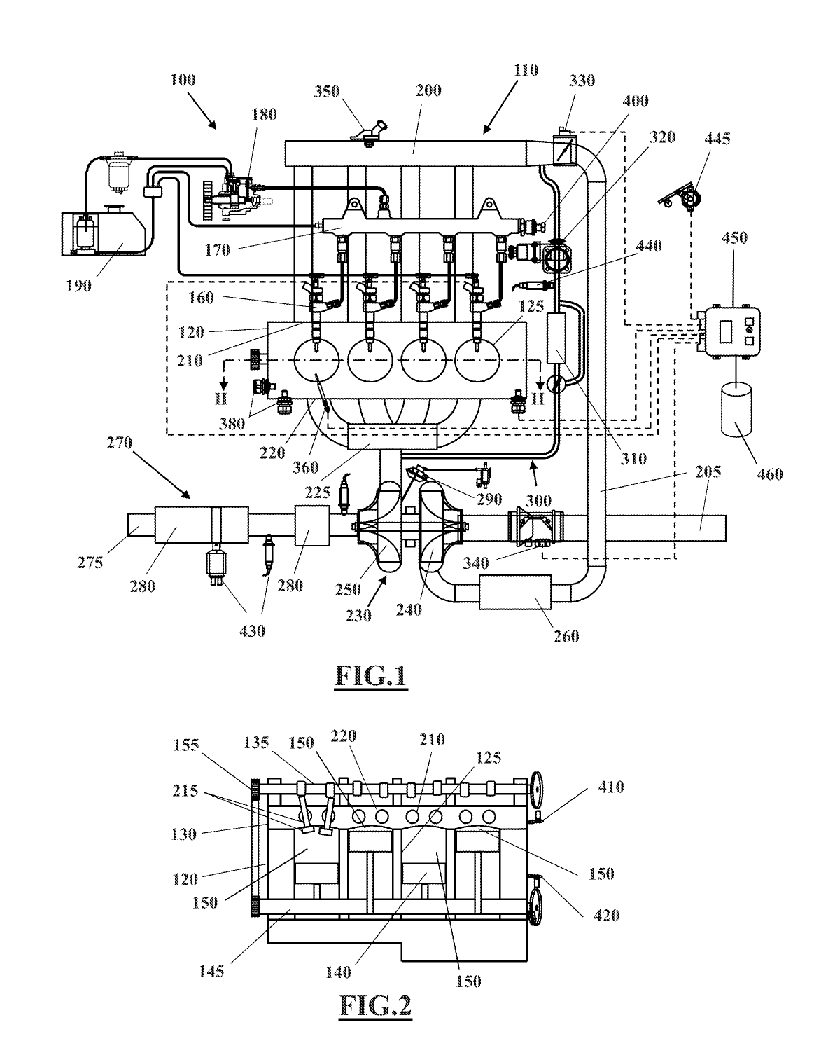

In an embodiment, an automotive system 100, as shown in FIGS. 1 and 2, includes an internal combustion engine (ICE) 110 having an engine block 120 with one (or more) cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

More precisely, the combustion chamber 150 is configured for cyclically performing an engine cycle. In this example, each engine cycle involves two complete rotations of the crankshaft 145, which correspond to four strokes of the piston 140 in the related cylinder 125, including an intake stroke, in which the valves 215 allow air into the combustion chamber 150, a compression stroke, in which the valves 215 are closed allowing the piston to compress the air in the combustion chamber 150, an expansion stroke, in which the valves 215 are still closed and the piston moves due to the gas expansion, and an exhaust stroke, in which the valves 215 allow exhaust gases to exit the combustion chamber 150. The fuel is injected in the combustion chamber 150 nearly at the end of the compression stroke.

In an embodiment, the ICE 110 comprises four combustion chambers 150, each of which is provided for cyclically operating an engine cycle as explained above. The engine cycles operated in each of this combustion chambers 150 are staggered over time with respect to the engine cycles operated in the other combustion chambers 150, so that each phase of the engine cycle, such as for example the fuel injection and combustion phases, occurs in the different combustion chambers 150 at different times. As a result, the ICE 110 globally performs engine cycles in sequence, wherein the last (or current) engine cycle of the sequence is always performed in a different combustion chamber 150 than the previous engine cycle, and so forth.

The air may be distributed to the air intake port(s) 210 through an intake manifold 200. An air intake duct 205 may provide air from the ambient environment to the intake manifold 200. In other embodiments, a throttle body 330 may regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. FIG. 1 shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

In an embodiment, the automotive system 100 further includes an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

The automotive system 100 further may comprise an in-cylinder pressure sensor 360 located in just one of the combustion chambers 150, whereas no in-cylinder pressure sensor is provided in the other combustion chambers 150. The in-cylinder pressure sensor 360 is in communication with the ECU 450 and is configured to generate signals in proportion to the pressure within the related combustion chamber 150.

Turning now to the ECU 450, this apparatus may include a digital central processing unit (CPU) in communication with a memory system 460 and an interface bus. The CPU is configured to execute instructions stored as a program in the memory system 460, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

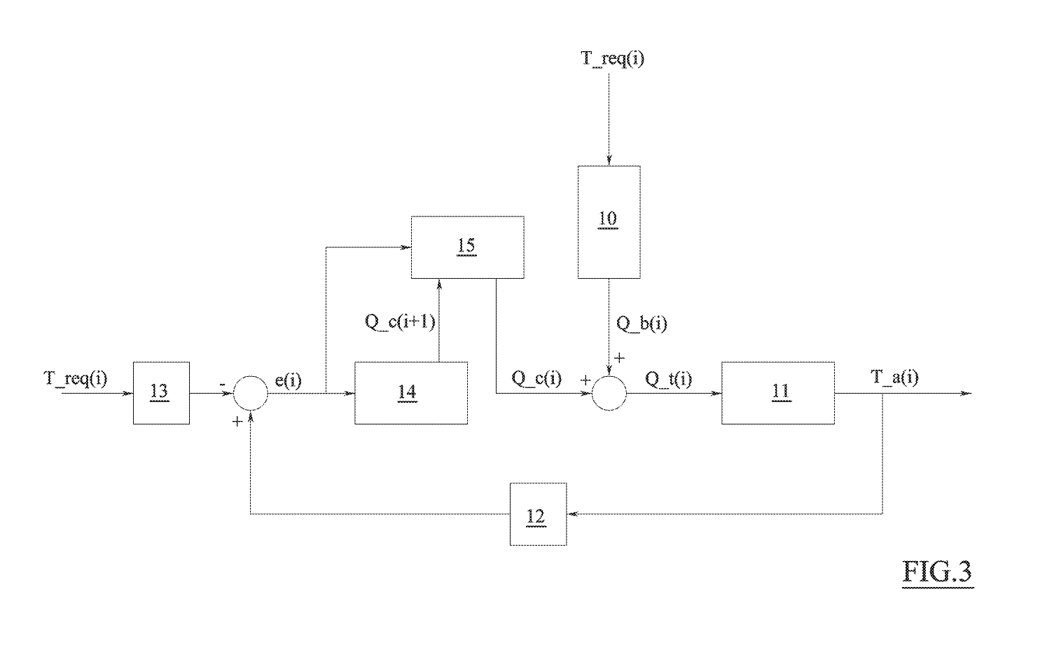

In one embodiment, the ECU 450 is configured to determine the quantity of fuel to be injected during each engine cycle and to operate the fuel injectors 160 accordingly. More precisely, since the engine cycles are operated in sequence and each time in a different combustion chamber 150 than the previous one, the ECU 450 is configured to cyclically determine the quantity of fuel to be injected during the last (current) engine cycle of the sequence, and to operate the fuel injector 160 of the related combustion chamber 150 accordingly. To accomplish this task, the strategy implemented by the ECU 450 for a generic current engine cycle “ith” is represented in the flowchart of FIG. 3. The ECU 450 first determines a requested value T_req(i) of engine torque to be generated in the current ith engine cycle, for example, on the basis of the current position of the accelerator pedal as provided by the sensor 445.

The requested engine torque value T_req(i) is then applied to a calibrated map 10 that, according to a feed-forward control logic, returns a base value Q_b(i) of a quantity of fuel to be injected during the current ith engine cycle. The fuel quantity base value Q_b(i) corresponds to the fuel quantity that will be expected to achieve the requested value T_req(i) of engine torque if the ICE 110 operates in ideal conditions.

The fuel quantity base value Q_b(i) is added to a correction value Q_c(i) of the quantity of fuel to be injected during the current ith engine cycle, which is determined and regulated according to a closed control loop of the engine torque as will be explained hereafter.

The addition of the fuel quantity base value Q_b(i) and the correction value Q_c(i) returns a total value Q_t(i) of the quantity of fuel to be injected during the current ith engine cycle, which is applied to an injection operating module 11, in order to operate the fuel injector 160 accordingly. At this point, the ECU 450 determines a value T_a(i) of the engine torque actually generated by the ICE 110 during the current ith engine cycle, due to the injection of the total value Q_t(i) of the fuel quantity. The method the ECU 450 uses to determine the engine torque value T_a(i) will be disclosed below.

The engine torque determined value T_a(i) is feed-back and used to calculate an engine torque error e(i) for the current ith engine cycle as the difference between the engine torque value T_a(i) and the engine torque requested value T_req(i):

e(i)=T_{—}a(i)−T_req(i)

In order to disregard values affected by noises, before the calculation of the engine torque error e(i), the engine torque value T_a(i) is filtered by means of a low-pass filter 12. To avoid a wrong calculation of the engine torque error e(i), the requested engine torque value T_req(i) also is filtered by a low-pass filter 13 of the same kind.

The calculated engine torque error e(i) is applied to a controller 14, for example, a proportional-integrative controller, that determines the correction value Q_c(i+1) of the fuel quantity to be injected in the next (i+1)th engine cycle. The new correction value Q_c(i+1) is determined on the basis of the engine torque error e(i) and of the previous correaction value Q_c(i), in order to minimize the engine torque error in the next engine cycle. Therefore, the correction value Q_c(i+1) is stored in a memory module 15, and then is used when the ECU 450 repeats the control loop for the next (i+1)th engine cycle, and so forth.

It should be observed that the memory module 15 acquires also the engine torque error e(i), so that, at the beginning of the next (i+1)th engine cycle, the ECU 450 is aware of the correction value Q_c(i+1) for the beginning engine cycle, as well as of the correction value Q_c(i) for the previous engine cycle and of the engine torque error e(i) of that previous engine cycle. Since the control strategy is repeated cyclically, this is true for each generic engine cycle.

Turning now to the determination of the engine torque value T_a(i), the ECU 450 operates differently depending on whether the ith engine cycle occurs in the combustion chamber 150 equipped with the in-cylinder pressure sensor 360 or in one of the remaining combustion chambers 150 without this sensor.

In the first case, the ECU 450 calculates the engine torque value T_a(i) on the basis of the pressure signal generated by the in-cylinder pressure sensor 360 during the ith engine cycle, using the well-known relationship between pressure in the combustion chamber 150 and torque generated at the crankshaft 145. In other words, the ECU 450 indirectly measures the engine torque value T_a(i) through the in-cylinder pressure sensor 360.

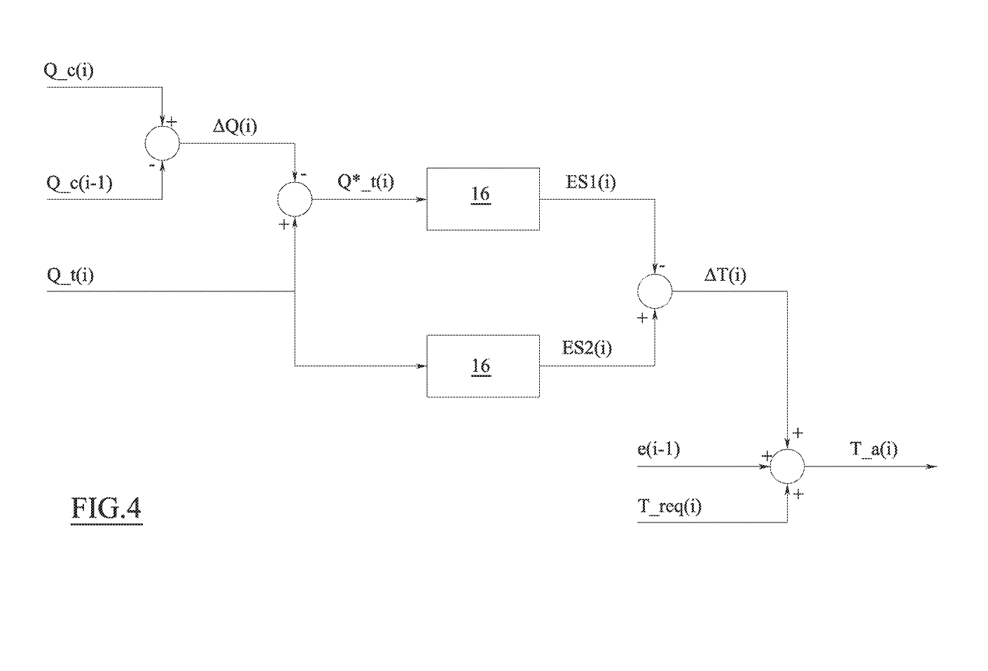

If conversely, the ith engine cycle occurs in a combustion chamber 150 without an in-cylinder pressure sensor, then the ECU 450 estimates the engine torque value T_a(i) according to the strategy shown in the flowchart of FIG. 4. This strategy uses as inputs the engine torque requested value T_req(i) for the current ith engine cycle, the total value Q_t(i) of fuel quantity injected in the current ith engine cycle, the fuel quantity correction value Q_c(i) for the current ith engine cycle, the fuel quantity correction value Q_c(i−1) for the previous (i−1)th engine cycle, and the engine torque error e(i−1) calculated for that previous (i−1)th engine cycle.

According to this strategy, the ECU 450 calculates an incremental value ΔQ(i) of the fuel quantity as the difference between the fuel quantity correction value Q_c(i) for the current ith engine cycle and the fuel quantity correction value Q_c(i−1) for the previous (i−1)th engine cycle:

ΔQ(i)=Q_{—}c(i)−Q_{—}c(i−1).

In this regard, the incremental value ΔQ(i) quantifies the contribution of fuel that the closed control loop of the engine torque has caused between the previous (i−1)th engine cycle and the current ith engine cycle. The ECU 450 then calculates an intermediate value Q*_t(i) of the fuel quantity as the difference between the total value Q_t(i) of fuel quantity injected in the current ith engine cycle and the calculated incremental value ΔQ(i) for the same ith engine cycle:

Q*_{—}t(i)=Q_{—}t(i)−ΔQ(i)

The intermediate value Q*_t(i) quantifies the amount of fuel that would be injected during the current ith engine cycle if the closed loop control of the engine torque was absent.

The fuel quantity intermediate value Q*_t(i) is then applied as input to a calibrated conversion map 16, which returns as output a first estimated value ES1(i) of engine torque that quantifies the engine torque which is expected to be generated during the current ith engine cycle, due to the injection of a quantity of fuel equal to the intermediate value Q*_t(i).

At the same time, the fuel quantity total value Q_t(i) is applied as input to the same calibrated conversion map 16, which returns as output a second estimated value ES2(i) of engine torque that quantifies the engine torque which is expected to be generated in the current ith engine cycle, due to the injection of a quantity of fuel equal to the total value Q_t(i). The conversion map 16 is per se known.

At this point, the ECU 450 calculates an incremental value ΔT(i) of engine torque as the difference between the second estimated value ES2(i) and the first estimated value ES1(i) of engine torque:

ΔT(i)=ES2(i)−ES1(i)

In this regard, the incremental value ΔT(i) quantifies the contribution of engine torque that has been generated during the ith engine cycle due to the incremental value ΔQ(i) of fuel.

In principle, it could be possible to estimate the incremental value ΔT(i) of engine torque by applying the incremental value ΔQ(i) of fuel directly to the conversion map 16. However, the results of the known conversion map 16 are generally not sufficiently reliable for a small amount of fuel, so that it is advisable to convert Q_t(i) and Q*_t(i) as explained above.

Finally, the ECU 450 estimates the engine torque value T_a(i) according to the following formula:

T_{—}a(i)=T_req(i)+ΔT(i)+e(i−1)

wherein T_req(i) is the requested value of engine torque to be generated in the current ith engine cycle, e(i−1) is the engine torque error calculated for the previous (i−1)th engine cycle and stored in the memory module 15, and ΔT(i) is the incremental value of engine torque.

It should be understood that the estimation strategy explained above can be used also for the engine cycles performed in the combustion chamber 150 equipped with the in-cylinder pressure sensor 360, for example in order to continue to reliably perform the closed control loop of the engine torque even when a fault of the in-cylinder pressure sensor 360 occurs.

In an embodiment, the strategy described above is performed by the ECU 450 with the aid of a computer program stored in the memory system 460 connected to the ECU 450 so that when the ECU 450 runs the program all the steps of the strategy are carried out.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

What is claimed is:

1. A method for operating an internal combustion engine, the method comprising the steps of:
injecting a quantity of fuel in the internal combustion engine per engine cycle, wherein a total value of the quantity of fuel is evaluated as a sum of a fuel quantity base value and a fuel quantity correction value, wherein the fuel quantity base value is determined on a basis of a requested value of engine torque to be generated in the engine cycle, and wherein the fuel quantity correction value is determined on a basis of an engine torque error in a previous engine cycle, which is calculated as a difference between a value of engine torque generated in the previous engine cycle and the requested value of engine torque for the previous engine cycle, the value of engine torque generated in the engine cycle being estimated with the steps of:
calculating an incremental value of fuel quantity as a difference between the fuel quantity correction value determined for the engine cycle and the fuel quantity correction value determined for the previous engine cycle;
calculating an incremental value of engine torque generated in the engine cycle due to the incremental value of fuel quantity; and
estimating the value of engine torque generated in the engine cycle as a sum of the incremental value of engine torque, the requested value of engine torque for the engine cycle, and the engine torque error calculated for the previous engine cycle.

2. A method according to claim 1, wherein the incremental value of engine torque is calculated with the steps of:
calculating an intermediate value of the quantity of fuel injected during the engine cycle as a difference between the total value of the quantity of fuel and the incremental value of fuel quantity for the engine cycle;
estimating a first value of engine torque generated in the engine cycle due to the intermediate value of the quantity of fuel;
estimating a second value of engine torque generated in the engine cycle due to the total value of the quantity of fuel; and
calculating the incremental value of engine torque as a difference between the second value of engine torque and the first value of engine torque.

3. A method according to claim 2, wherein the estimating of the first value of engine torque and the second value of engine torque are performed using a conversion map receiving a fuel quantity value as input and returning an engine torque value as output.

4. A method according to claim 1, wherein the requested value of engine torque to be generated in the engine cycle and the value of engine torque generated in the engine cycle are individually filtered by a filter of the same kind before calculating the engine torque error for the engine cycle.

5. A computer program product, comprising a non-transitory computer usable medium having a computer readable program code embodied therein, the computer readable program code adapted to be executed to implement a method operating an internal combustion engine, the method comprising the steps of:
injecting a quantity of fuel in the internal combustion engine per engine cycle, wherein a total value of the quantity of fuel is evaluated as a sum of a fuel quantity base value and a fuel quantity correction value, wherein the fuel quantity base value is determined on a basis of a requested value of engine torque to be generated in the engine cycle, and wherein the fuel quantity correction value is determined on a basis of an engine torque error in a previous engine cycle, which is calculated as a difference between a value of engine torque generated in the previous engine cycle and the requested value of engine torque for the previous engine cycle, the value of engine torque generated in the engine cycle being estimated with the steps of:
calculating an incremental value of fuel quantity as a difference between the fuel quantity correction value determined for the engine cycle and the fuel quantity correction value determined for the previous engine cycle;
calculating an incremental value of engine torque generated in the engine cycle due to the incremental value of fuel quantity; and
estimating the value of engine torque generated in the engine cycle as a sum of the incremental value of engine torque, the requested value of engine torque for the engine cycle, and the engine torque error calculated for the previous engine cycle.

6. The computer program product according to claim 5, wherein the incremental value of engine torque is calculated with the steps of:
calculating an intermediate value of the quantity of fuel injected during the engine cycle as a difference between the total value of the quantity of fuel and the incremental value of fuel quantity for the engine cycle;
estimating a first value of engine torque generated in the engine cycle due to the intermediate value of the quantity of fuel;
estimating a second value of engine torque generated in the engine cycle due to the total value of the quantity of fuel; and
calculating the incremental value of engine torque as a difference between the second value of engine torque and the first value of engine torque.

7. The computer program product according to claim 6, wherein the estimating of the first value of engine torque and the second value of engine torque are performed using a conversion map receiving a fuel quantity value as input and returning an engine torque value as output.

8. The computer program product according to claim 5, wherein the requested value of engine torque to be generated in the engine cycle and the value of engine torque generated in the engine cycle are individually filtered by a filter of the same kind before calculating the engine torque error for the engine cycle.

9. An automotive system comprising:
an internal combustion engine comprising an engine block defining a set of cylinders, each of which is provided with a reciprocating piston, with a cylinder head that cooperates with the reciprocating piston to define a combustion chamber, and with a fuel injector for injecting fuel into the combustion chamber; and
an electronic control unit in communication with the fuel injector, wherein the electronic control unit is configured for:
operating the fuel injector to inject a quantity of fuel in a related combustion chamber per engine cycle;
evaluating a total value of a fuel quantity injected for each engine cycle as a sum of a fuel quantity base value and a fuel quantity correction value;
determining the fuel quantity base value on a basis of a requested value of engine torque to be generated in an engine cycle;
determining the fuel quantity correction value on a basis of an engine torque error in a previous engine cycle;
calculating the engine torque error in the previous engine cycle as a difference between a value of engine torque generated in the previous engine cycle and the requested value of engine torque for the previous engine cycle;
estimating the value of engine torque generated in the engine cycle with the steps of:
calculating an incremental value of fuel quantity as a difference between the fuel quantity correction value determined for the engine cycle and the fuel quantity correction value determined for the previous engine cycle;
calculating an incremental value of engine torque generated in the engine cycle due to the incremental value of fuel quantity; and
estimating the value of engine torque generated in the engine cycle as a sum of the incremental value of engine torque, the requested value of engine torque for the engine cycle, and the engine torque error calculated for the previous engine cycle.
